(19) United States
(12) Patent Application Publication
(10) Pub. No.: US 2007/0294568 A1
(43) Pub. Date: Dec. 20, 2007

(54) Storage system and method of managing data using the same

(76) Inventors: Yoshimasa Kanda, Odawara (JP); Hiroshi Wake, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/493,657

(22) Filed: Jul. 27, 2006

(30) Foreign Application Priority Data
Jun. 2, 2006 (JP) 2006-154935

(51) Int. Cl. G06F 11/00

(52) U.S. Cl. 714/6

(57) ABSTRACT

A storage apparatus includes a storage unit and a controller for controlling the storage unit. A data volume, a journal volume, and a snapshot volume are formed in the storage unit. The storage apparatus stores, in accordance with a write request sent from a host apparatus, data specified in the write request in the data volume, and also stores, in accordance with a restoration point setting request sent from the host apparatus including a host apparatus timestamp, backup data associated with that host apparatus timestamp in a specific volume. In restoring data, the storage apparatus applies snapshot data to the data volume with reference to the host apparatus timestamp included in the restoration request sent from the host apparatus, and further applies journal data, thereby restoring data. Accordingly, the storage apparatus enables data restoration in response to a restoration request designating a particular time based on the time in the host apparatus.

### CROSS-REFERENCES TO RELATED APPLICATIONS

This application relates to and claims priority from Japanese Patent Application No. 2006-154935, filed on Jun. 2, 2006, the entire disclosure of which is incorporated herein by reference

### BACKGROUND

1. Field of the Invention

The present invention relates to a storage system and a data management method using the same. More specifically, the invention relates to a storage system employing a snapshot technology and a journaling technology, and a data backup and restoration method applying those technologies.

2. Description of Related Art

In order to prevent data loss in computer systems, data is backed up, and restored/recovered using storage systems. Snapshot technology and journaling technology are conventionally known in the art for backing up data used in a computer system. The snapshot technology includes storing data images for a file system at a particular point in time. For example, if data has been lost due to a failure, the data can be restored to the state prior to the data loss, by referring to the stored snapshot data. The journaling technology includes storing, upon a data write, the data to be written and the time of the data-write, as a journal entry journal data). Recently, storage apparatuses provided with a high-speed data restoration mechanism combining the journaling and snapshot technologies have been receiving attention.

As one example, JP Patent Laid-open Publication No. 2005-18738 discloses a storage apparatus that, in response to a write request from a host apparatus, stores a journal entry for application data to be stored in a data volume and also stores snapshot data for the data volume. In this storage apparatus, the journal entry and the snapshot data are assigned unique numbers in the order in which they are generated. By way of this configuration, when restoring data, the storage apparatus allows a target journal entry associated with selected snapshot data to be easily identified, thereby resulting in high-speed data restoration.

Conventional storage apparatuses have been designed such that data is restored based on a point in time designated by a user according to a time reference clocked in the storage apparatuses. However, generally, failures often occur on the part of host apparatuses, depending on, for example, errors in operation before a host apparatus. If a failure occurs in a host apparatus, the host apparatus provides the user with failure information including the contents and time of the failure, which the failure time depends on a time reference clocked by a timer in the host apparatus. The user designates a particular point in time to which data is to be restored, referring to the failure time. In contrast, data restoration is performed in the storage apparatus based on time depending on a timer in the storage apparatus. Accordingly, if there is a time gap (time difference) between the timer in the host apparatus and the timer in the storage apparatus, expected data which would exist in the time designated by the user may not be restored.

Also, in a distributed system where a plurality of host apparatuses operate in cooperation with each other, it is assumed that timers in the individual host apparatuses indicate different times. Thus, in this type of system, it has not been possible to determine one unique standard time, and accordingly it is difficult to restore data in the overall system in synchronization based on the same standard time.

### SUMMARY

According to one aspect of the present invention, provided is a storage apparatus that backs up data as required, and, in response to a restoration request from a host apparatus, restores the backed up data. The storage apparatus includes a storage unit having a data volume and a backup volume formed therein, and a controller configured to control the storage unit. Typically, the backup volume includes a journal volume, a snapshot volume and a command management volume. These volumes are typically managed by way of using a volume management table. Furthermore, in accordance with a write request sent from the host apparatus, the controller stores data associated with the write request into the data volume. The controller also stores, in accordance with a restoration point setting request sent from the host apparatus including a host apparatus timestamp, the backup data associated with the host apparatus timestamp into the backup volume.

If the controller receives a restoration request from the host apparatus designating a host apparatus timestamp and if data as of a backup point in time has no host apparatus timestamp, the controller first obtains a difference time based on a storage apparatus timestamp and host apparatus timestamp stored in association with each other in a snapshot volume management table in the volume management table. Then, the controller specifies a snapshot data corresponding to the storage apparatus timestamp closest in time to the host apparatus timestamp included in the restoration request, using an offset timestamp based on the obtained difference time, and thereafter applies the specified snapshot data to the data volume.

Accordingly, if the storage apparatus receives a restoration request including a host apparatus timestamp from the host apparatus, the storage apparatus can restore data using the stored host apparatus timestamps. Even if no host apparatus timestamp is stored, the controller can restore data based on the timestamp as close in time as possible to the host apparatus timestamp included in the restoration request, using another host apparatus timestamp stored in the storage apparatus.

Therefore, according to the present invention, a storage apparatus can restore data to the state as expected by a user, based on the time reference in a host apparatus.

Other aspects and advantages of the invention will be apparent from the following description and the appended claims.

### BRIEF DESCRIPTION OF THE DRAWINGS

FIG. 1 is a diagram illustrating a storage system according to an embodiment of the invention.

FIG. 2 illustrates a program stack structure in a host apparatus in a storage system according to an embodiment of the invention.

FIG. 3 is a diagram for explaining a memory of a controller in a storage apparatus according to an embodiment of the invention.

FIG. 4 is a flow chart for explaining processing executed in a host apparatus in a storage system according to an embodiment of the invention.

FIGS. 5A and 5B illustrate a data format of a request command used in a storage system according to an embodiment of the invention.

FIG. 6 illustrates a restoration point setting parameter table used in a storage system according to an embodiment of the invention.

FIG. 7 is a flow chart for explaining processing executed in a storage apparatus in a storage system according to an embodiment of the invention.

FIG. 8 is a flow chart for explaining processing of command management volume control achieved by a control program executed on a controller of a storage apparatus in a storage system according to an embodiment of the invention.

FIG. 9 is a flow chart for explaining snapshot processing achieved by a control program executed on a controller of a storage apparatus in a storage system according to an embodiment of the invention.

FIG. 10 illustrates a volume management table managed in a controller of a storage apparatus in a storage system according to an embodiment of the invention.

FIG. 11 is a flow chart for explaining journaling processing achieved by a control program executed on a controller of a storage apparatus in a storage system according to an embodiment of the invention.

FIG. 12 illustrates a configuration of a journal volume in a storage apparatus in a storage system according to an embodiment of the invention.

FIG. 13 is a flow chart for explaining restoration processing achieved by a control program executed on a controller of a storage apparatus in a storage system according to an embodiment of the invention.

FIG. 14 is a flow chart for explaining restoration processing achieved by a control program executed on a controller of a storage apparatus in a storage system according to an embodiment of the invention.

FIG. 15 is a time sequence for explaining data backup and restoration processing in a storage system according to an embodiment of the invention.

### DETAILED DESCRIPTION OF PREFERRED EMBODIMENTS

The foregoing and other objects, features and advantages of the invention will be apparent from the following more particular description of preferred embodiments of the invention, as illustrated in the accompanying drawings.

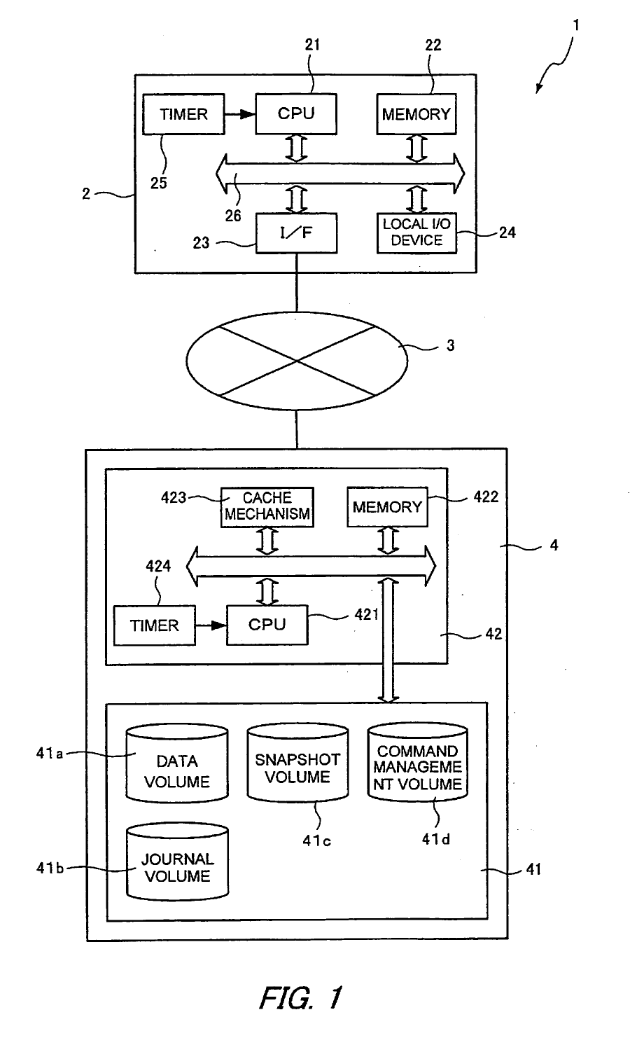

FIG. 1 illustrates a configuration of a storage system according to an embodiment of the invention. A storage system 1 includes a host apparatus 2, which serves as an upper device, and a storage apparatus 4, which serves as a lower device, connected to each other via a network system 3.

The host apparatus 2 may be a personal computer, workstation, or mainframe. The host apparatus 2 has hardware resources, such as a CPU (Central Processing Unit) 21, a main memory 22, an interface unit 23, a local I/O device 24, and a timer 25, which are interconnected via an internal bus 26. The host apparatus 2 also has software resources, such as a device driver and an operating system (OS). By this configuration, the host apparatus 2 executes various programs under control of the CPU 21, and achieves desired processing in cooperation with the hardware resources. For example, under the control of the CPU 21, the host apparatus 2 executes an application program on the OS. The application program is a program for achieving the processing that the host apparatus 2 primarily intends to execute. Upon its execution, the application program requests access (such as data-read or data-write) to the storage apparatus 4. For such access, a storage manager may be installed on the host apparatus 2. The storage manager is a management program for managing access to the storage apparatus 4. The storage manager may be separate from the OS. Alternatively, it may be incorporated to form a part of the OS. Various programs may be configured as a single module or as a plurality of modules.

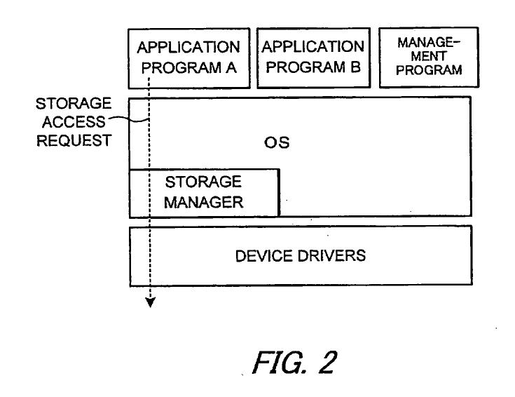

FIG. 2 illustrates a program stack structure in a host apparatus disposed in a storage system according to an embodiment of the invention. When an access request is made from the application program to the storage apparatus 4, the storage manager issues a specific command to the storage apparatus 4. For example, upon a data read or write request, the storage manager issues a read or write request command. These read request commands and write request commands are processed as normal I/O request commands. The storage manager in this embodiment also controls restoration point setting processing and restoration processing. The processing controlled by the storage manager will be explained in detail later.

Referring back to FIG. 1, the network system 3 is, for example, a SAN (Storage Area Network), LAN (Local Area Network), internet, public line, dedicated line, or similar. Communication between the host apparatus 2 and the storage apparatus 4 via the above network system 3 is performed in accordance with, for example, Fibre Channel Protocol if the network 3 is a SAN, or TCP/IP (Transmission Control Protocol/Internet Protocol) if the network 3 is a LAN.

The storage apparatus 4 includes a storage unit 41 comprising a plurality of physical disk devices, and a controller 42 for controlling the storage unit 41.

The disk devices are selected from, for example, FC (Fibre Channel) disks, FATA (Fibre Attached Technology Adapted) disks, SATA (Serial AT Attachment) disks, optical disk drives, or similar. In a storage area provided by one or more disk devices, one or more logically defined volumes (hereinafter referred to as logical volumes) are established.

The logical volumes are given an attribute according to their purpose of use, and managed in accordance with their assigned unique identifier (LUN: Logical Unit Number). In this embodiment, a data volume 41a, a journal volume 41b, a snapshot volume 41c, and a command management volume 41d are defined in the storage unit 41. It would understood that the journal volume 41b, the snapshot volume 41c, and the command management volume 41d function as volumes for data backup.

The data volume 41a is a volume used when the application program reads/writes data. The journal volume 41b is a volume for storing journal data, which is update history information of the data volume 41a. The journal data typically includes: data written to the data volume 41a, an address in the data volume 41a to which the data has been written, and management information, e.g., the time when the data was written. The snapshot volume 41c is a volume for storing snapshot data (images) of the data volume 41a at particular points in time. The command management volume 41d is a volume for temporarily holding specific commands sent from the host apparatus 2.

The logical volumes are accessed in blocks of a specific size. Each block is given a logical block address (LBA). Thus, the host apparatus 2 accesses a target storage area the logical volumes by specifying an address based on the above-described identifier and logical block address to the controller 42 in the storage apparatus 4.

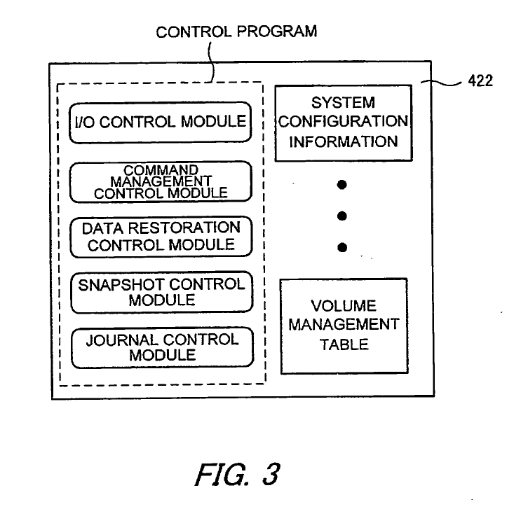

The controller 42 is configured as a system circuit including, among other things, a CPU 421, memory 422, a cache mechanism 423, and a timer 424, and thereby performs overall control over inputs/outputs between the host apparatus 2 and the storage unit 41. Also, the controller 42 may typically include one or more channel adapters and one or more disk adapters (not shown in the drawing). The memory 422 functions as the main memory for the CPU 421. For example, as shown in FIG. 3, the memory 422 stores a control program including various modules, system configuration information, a management table, etc., to be used by the CPU 421. Though not shown in the drawing, the controller 42 monitors, during its operation, whether or not any failure occurs in the storage apparatus 4, and is also provided with a module for executing informing a user (system administrator) if a failure occurs. The control program and various kinds of information, etc., as discussed above are, for example, read out from specific disk devices and loaded into the memory 422 at the time when the storage apparatus 4 is powered on, under the control of the CPU 421. Alternatively, if the memory 422 is configured to include a rewritable-nonvolatile RAM, such program and information may be constantly kept on that nonvolatile RAM.

The cache mechanism 423 comprises a cache memory, and is used for temporarily storing data input/output between the host apparatus 2 and the storage unit 41. Specifically, commands sent from the host apparatus 2 are temporarily held in the cache memory, and data read from the data volume 41a in the storage unit 41 is temporarily held in the cache memory before being transmitted to the host apparatus 2.

The timer 424 keeps time, and provides the CPU 421 with timestamps, as necessary. The term “timestamp” is used here as a broad meaning including data indicating a particular point in time, a particular date, or a combination of both. The control program utilizes those timestamps under the control of the CPU 421.

The storage system 1 according to this embodiment is designed to be able to restore data using timestamps based on the time indicated by the timer in the host apparatus 2 (hereinafter referred to as “host apparatus timestamps”) and to be also able to restore data using timestamps based on the time indicated by the timer in the storage apparatus 4 (hereinafter referred to as “storage apparatus timestamps”). More specifically, the host apparatus 2 transmits an obtained host apparatus timestamp together with a specific command to the storage apparatus 4, and thereby the storage apparatus 4 stores that host apparatus timestamp sent from the host apparatus 2 in a specific area. In doing so, the storage apparatus 4 restores data using the stored host apparatus timestamps if it receives a restoration request specifying a time in the host apparatus.

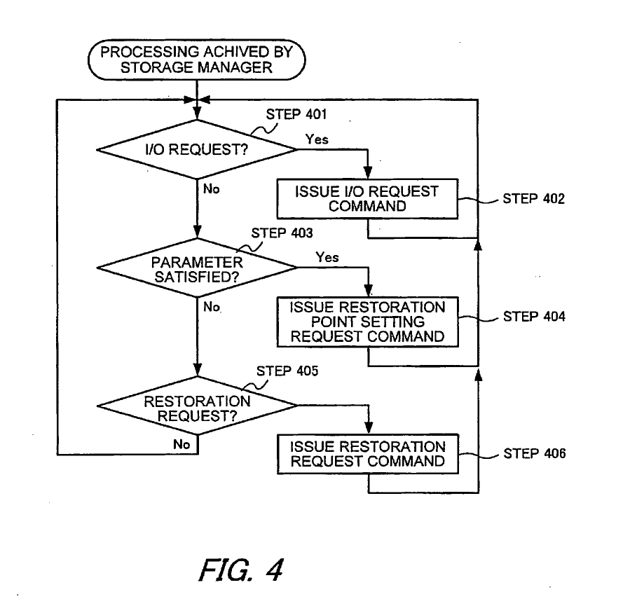

FIG. 4 is a flow chart for explaining processing executed in a host apparatus in a storage system according to an embodiment of the invention. Specifically, FIG. 4 describes the flow of the processing achieved by the storage manager executed on the host apparatus 2. The storage manager is booted up, for example, with the boot-up of the host apparatus 2, and resides in the main memory 22.

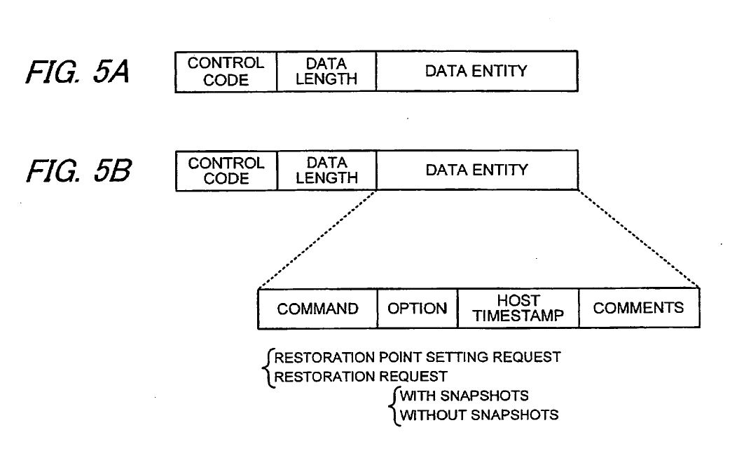

More specifically, as shown in FIG. 4, the storage manager monitors whether or not any I/O request is made by the application program to the storage apparatus 4 (STEP 401). The I/O request used here means a normal data read or data write request. For example, when receiving a data write request, the storage manager generates a write request command including a data entity to be written to the storage apparatus 4, and transmits the command to the storage apparatus 4 (STEP 402). FIG. 5A shows the data format of a write request command. Referring to FIG. 5A, a write request command includes a control code field, a data length field, and, a data entity field. The data entity field may be a variable-length field for holding a data entity to be written.

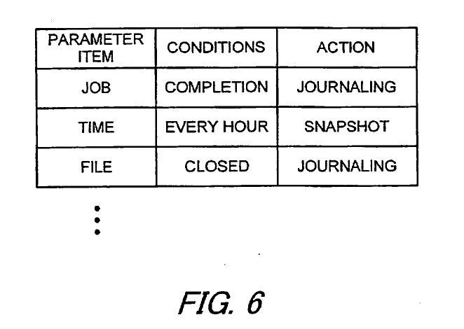

The storage manager also monitors whether the system status of the host apparatus 2 satisfies any parameters defined in a restoration point setting parameter table or not (STEP 403). The restoration point setting parameter table is a table that defines parameters for setting restoration points, item by item. FIG. 6 is a diagram for explaining the restoration point setting parameter table in this embodiment. In FIG. 6, for example, whether a specific job has been completed in the host apparatus 2; whether the time in the host apparatus 2 has reached a specific time; and whether a specific file has been closed are defined as parameters for setting a restoration point. Also, the “action” field defines a backup manner to be executed when the relevant parameter has been satisfied, indicating either backup involving journaling or backup involving snapshots in this embodiment. Thus, according to the restoration point setting parameter table shown in FIG. 6, for example, if a specific job has been completed, or if a specific file has been closed, backup involving journaling will be executed. Also, if the time is 00 minutes after the hour, backup involving snapshots will be executed. The restoration point setting parameter table is an editable table, and a system administrator, for example, may change the parameters, or define new parameters, using a dialogue box provided by the storage manager.

Referring back to FIG. 4, if the storage manager has determined that the system status of the host apparatus 2 satisfies any parameter defined in the restoration point setting parameter table (“Yes” in STEP 403), the storage manager generates a restoration management request command according to that parameter, and then transmits the command to the storage apparatus 4 (STEP 404). In this embodiment, the restoration management request command is a command for either a restoration point setting request or a restoration request, and, as explained later, this command is written to the command management volume 41d in the storage apparatus 4.

FIG. 5B shows a data format of a restoration management request command. As shown in FIG. 5B, a restoration management request command includes a control code field, a data length field, and a data field. The data field further includes a command field, an option field, a host apparatus timestamp field, and a comment field. The command field is used to designate either a restoration point setting request or a restoration request. If any of the parameters defined in the restoration point setting parameter table have been determined as being satisfied, a restoration point setting request is set in the command field. The option field is used to specify whether snapshots should be made or not. If “Without snapshots” is set in the option field, this means that journaling is specified. A restoration management request command where a restoration point setting request is set in its command field may also simply be referred to as a restoration point setting request command. The comment field constitutes a part of the journal data to be stored in the journal volume.

The storage manager also monitors whether or not any restoration request has been given (STEP 405). The restoration request is, for example, given by a user via a dialogue box provided by the storage manager. When receiving any restoration request, the storage manager generates a restoration management request command and then transmits the command to the storage apparatus 4 (STEP 406). As described above, a restoration request is set in the command field of the here-generated restoration management request command. A restoration management request command where a restoration request is set in its command field may also simply be referred to as a restoration request command.

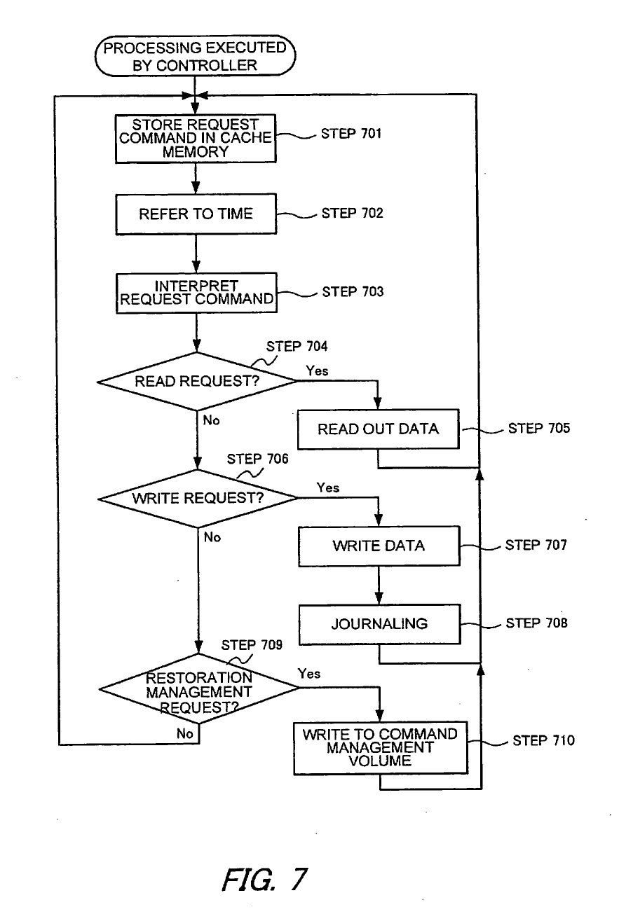

FIG. 7 is a flow chart for explaining processing executed in the storage apparatus 4 in a storage system according to an embodiment of the invention. Specifically, FIG. 7 describes the flow of the processing achieved by the control program executed on the controller 42 in the storage apparatus 4. As previously shown in FIG. 3, the control program includes various control modules, and achieves required processing by calling the relevant control module from the main module (not shown in FIG. 3) as necessary.

Referring to FIG. 7, if a request command sent from the host apparatus 2 is stored in the cache memory in the cache mechanism 423 (STEP 701), the controller 42 refers to the timer to obtain a timestamp (STEP 702), and also interprets the request command (STEP 703). If the request command is a read request (“Yes” in STEP 704), the controller 42 reads data from the data volume 41a in accordance with the specified address (STEP 705). The data-read makes no actual change to the data volume 41a, and thus, no journaling is performed. In contrast, if the request command is a write request (“Yes” in STEP 706), the controller 42 writes data to the data volume 41a in accordance with the specified address (STEP 707), and then performs journaling (STEP 708). The journaling is performed by way of storing the journal data, in which the write data including the specified address is associated with the obtained timestamp, into the journal volume 41b. It is note that the timestamp used here means the storage apparatus timestamp.

If the request command is a restoration management request (“Yes” in STEP 709), the controller 42 associates the restoration management request command with the obtained timestamp and writes the resulting command to the command management volume 41d (STEP 709). If the restoration management request command is a restoration point setting request, it includes the host apparatus timestamp. While the controller 42 monitors the command management volume 41d, if any request command exists in the command management volume 41d, the controller 42 also executes the processing according to the request command. The details will be explained below.

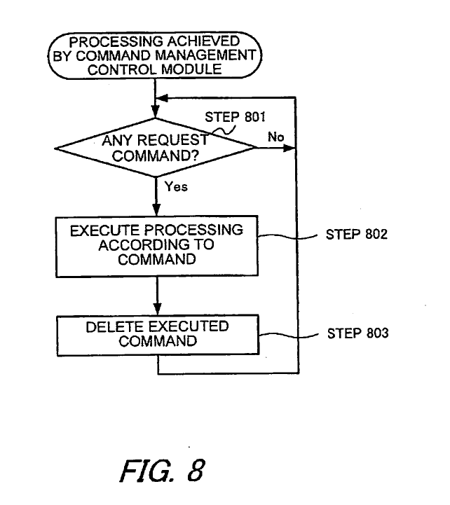

FIG. 8 is a flow chart for explaining processing regarding command management volume control achieved by a control program executed on a controller of a storage apparatus in a storage system according to an embodiment of the invention. Specifically, FIG. 8 describes processing of a command management control module, which is called by the control program on the controller 42.

Referring to FIG. 8, the controller 42 monitors whether or not any request command has been written to the command management volume 41d (STEP 801). If a command exists in the command management volume 41d (“Yes” in STEP 801), the controller 42 executes subroutine processing corresponding to the command (STEP 802). Thereafter, the controller 42 deletes the executed command from the command management volume 41d (STEP 803).

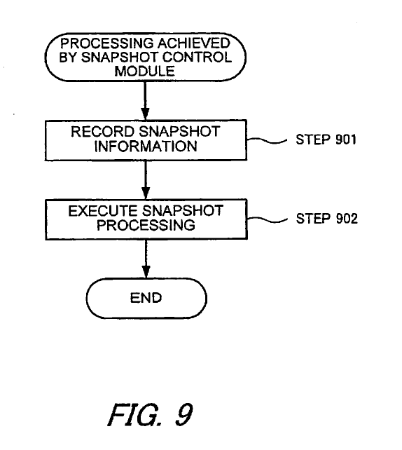

FIG. 9 is a flow chart for explaining snapshot processing achieved by a control program executed a controller of a storage apparatus in a storage system according to an embodiment of the invention. The snapshot processing is processing executed by a snapshot control module if “With snapshots” is set in a restoration point setting request command.

As shown in FIG. 9, the controller 42 first records snapshot information including the storage apparatus timestamp, host apparatus timestamp, etc., at an end of a snapshot volume list in a volume management table (STEP 901). If there is no snapshot volume list, as is the case in the initial state, the controller 42 creates a snapshot volume list. Then, the controller 42 obtains snapshot data for the data volume 41a, and stores the obtained snapshot data in the snapshot volume (STEP 902).

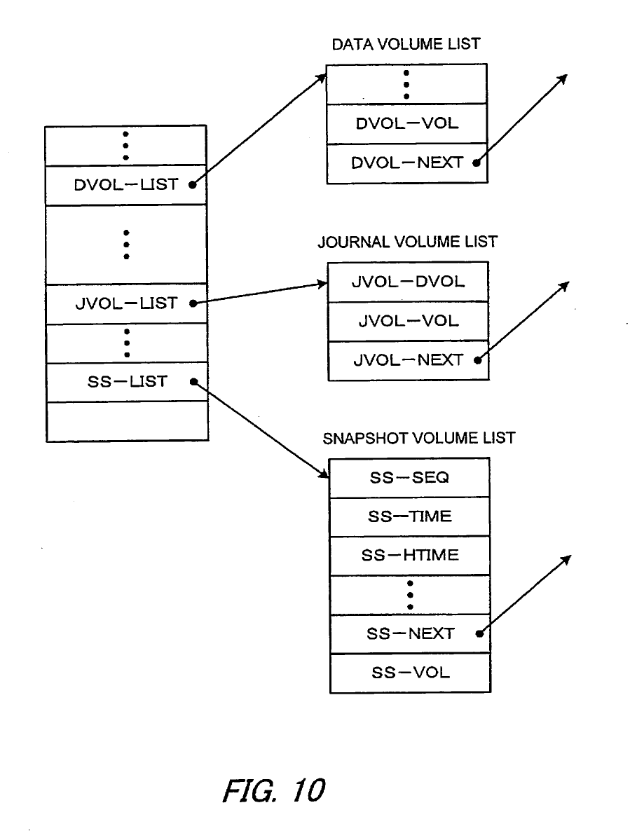

FIG. 10 is a diagram for explaining a volume management table managed in a controller of a storage apparatus in a storage system according to an embodiment of the invention.

As shown in FIG. 10, the volume management table is a table having a list structure, used for managing the logical volumes established in the storage unit 41. FIG. 10 shows a data volume 41a list, a journal volume list, and a snapshot volume list. One node in the snapshot volume list stores the snapshot information for the snapshot processing executed at any one time.

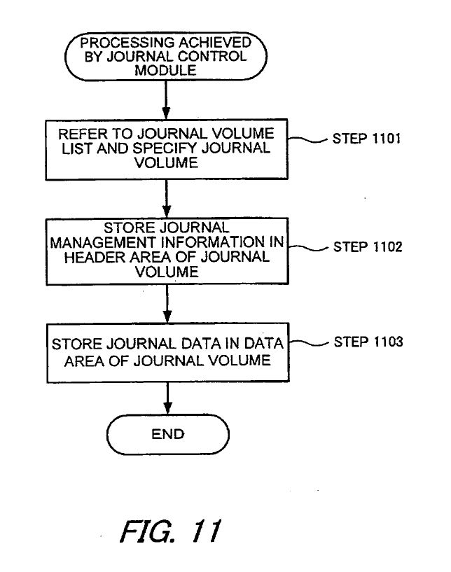

FIG. 11 is a flow chart for explaining journaling processing achieved by a control program executed on a controller of a storage apparatus in a storage system according to an embodiment of the invention. The journaling processing used here means processing achieved by a journal control module if “Without snapshots” is set in a restoration point setting request command.

Referring to FIG. 11, the controller 42 first refers to the journal volume list in the volume management table 41d, and specifies a journal volume 41b in which the relevant journal data is to be stored (STEP 1101). Specifically, a journal volume 41a is specified by referring to JVOL-DVOL in the journal volume list. Next, the controller 42 stores journal management information in the journal header area of the above specified journal volume 41b (STEP 1102). The journal management information includes, for example, the journal address, host apparatus timestamp and storage apparatus timestamp. Then, the controller 42 stores the relevant journal data in the journal data area of the above specified journal volume 41b (STEP 1103). In the journaling processing in accordance with a restoration management request command, the journal data may include comments stored in the comment field of the command.

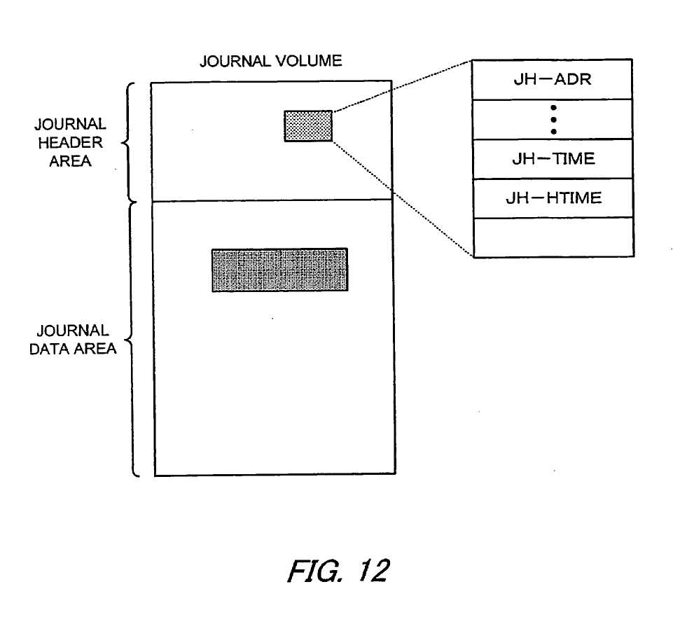

FIG. 12 is a diagram for explaining a configuration of a journal volume in a storage apparatus in a storage system according to an embodiment of the invention. As shown in FIG. 12, the journal volume 41b is includes the journal header area and the journal data area. For example, information necessary for the journal management, such as a journal address, a storage apparatus timestamp, and a host apparatus timestamp, is stored in the journal header area.

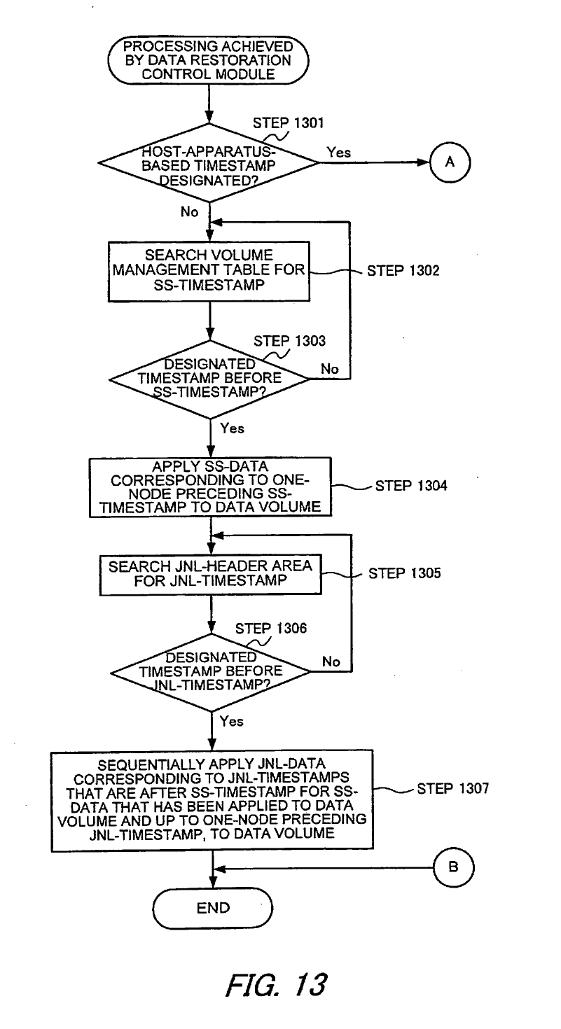

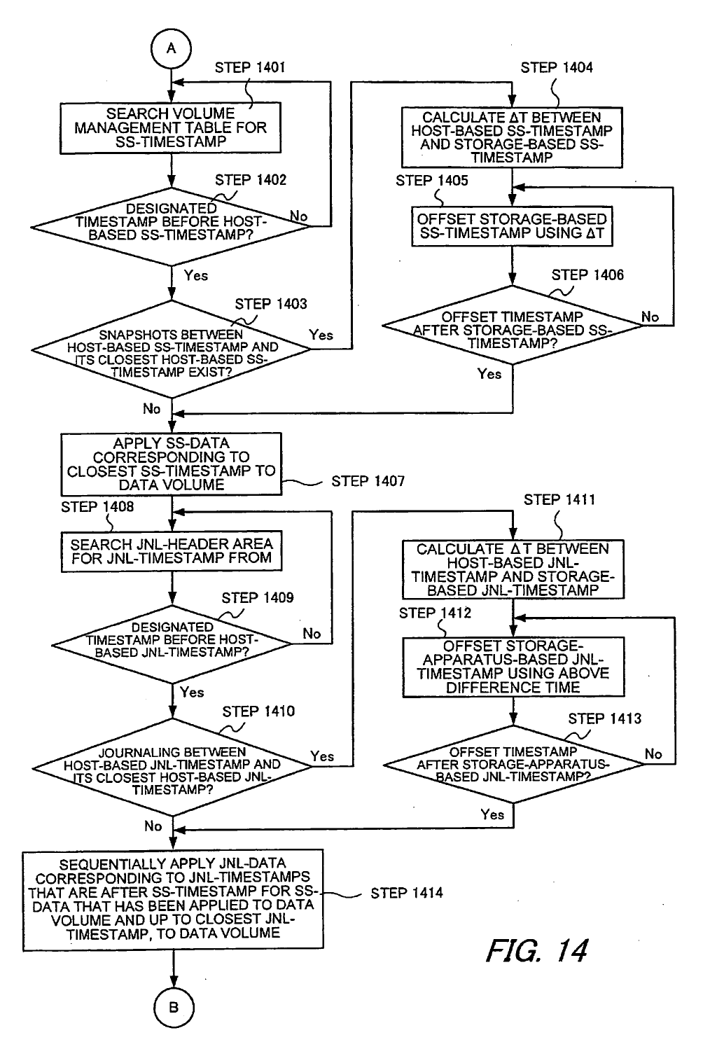

FIGS. 13 and 14 are flow charts for explaining restoration processing achieved by a control program executed on a controller of a storage apparatus in a storage system according to an embodiment of the invention. The restoration processing is processing executed by a restoration control module if a restoration request command is set in a restoration management request command.

Referring to FIGS. 13 and 14, in the restoration processing, the controller 42 determines whether the restoration request from the host apparatus 2 is to restore data based on the time in the host apparatus 2, or to restore data based on the time in the storage apparatus 4 (STEP 1301).

Specifically, the controller 42 determines whether the timestamp included in the restoration request command is based on the time in the host apparatus or based on the time in the storage apparatus. The timestamp included in the restoration request command is a timestamp indicating a particular point in time to which data restoration has been requested, i.e., specifying whether data should be restored based on the time in the host apparatus or based on the time in the storage apparatus. The timestamp is, for example, given by a user via a dialogue box provided by a recovery manager. The recovery manager may be designed to inquire from the controller 42 any point in time where restoration can be executed, and to provide a user with the inquiry result so that the user can select a particular time. If the timestamp included in the restoration request command is not based on the time in the host apparatus (“No” in STEP 1301), the controller 42 interprets the timestamp as being based on the time in the storage apparatus, and thus executes the processing described from STEP 1302 to STEP 1307. On the other hand, if the specified timestamp is based on the time in the host apparatus (“Yes” in STEP 1301), the controller 42 executes the processing described from STEP 1401 to STEP 1414 in FIG. 14.

More specifically, if the specified timestamp is not based on the time in the host apparatus, the controller 42 interprets the specified timestamp as being based on the time in the storage apparatus, and obtains the storage-based snapshot timestamp closest in time to the designated timestamp. Namely, the controller 42 refers to the snapshot volume list in the volume management table, and extracts one element, i.e., the timestamp indicating the particular point in time that the snapshot processing was executed (snapshot timestamp) SS-TIME(i), from a referenced node (STEP 1302). Then, the controller 42 compares the designated timestamp with the extracted snapshot timestamp SS-TIME(i), and determines whether the designated timestamp is before the extracted snapshot timestamp SS-TIME(i) (STEP 1303). If the designated timestamp coincides with the extracted snapshot timestamp SS-TIME(i), the controller 42 applies the snapshot data corresponding to the extracted snapshot timestamp SS-TIME(i) to the data volume 41a. This results in restoration of data as of the point in time that the system administrator has intended.

If the designated timestamp is not before the extracted snapshot timestamp SS-TIME(i) (“No” in STEP 1303), the controller 42 extracts the next snapshot timestamp SS-TIME(i=i+1) from the snapshot volume list (STEP 1302), and compares it in the same manner (STEP 1303). The extracting and comparing steps are repeated until an applicable snapshot timestamp SS-TIME(i) has been obtained. If an applicable timestamp has not been obtained even after comparing the designated timestamp with all snapshot timestamps SS-TIME(i; 0<i<n+1) in the snapshot volume list, the controller 42 may return an error message to the host apparatus 2, and ends the processing. If the designated timestamp is before the extracted snapshot timestamp (“Yes” in STEP 1303), the controller 42 selects the snapshot timestamp SS-TIME(S=i−1) of the preceding node relative to the snapshot timestamp SS-TIME(i) currently referred to, and then restores the data volume 41a based on the snapshot data corresponding to the selected snapshot timestamp SS-TIME(S) (STEP 1304). By way of this, data is restored using the snapshot data corresponding to the storage-based snapshot timestamp closest in time to the specified timestamp.

Further, The controller 42 refers to the journal header area in the journal volume 41b, and extracts a timestamp indicating a particular point in time that journaling was performed (journal timestamp) JH-TIME(i) (STEP 1305). Then, the controller 42 compares the designated timestamp with the extracted journal timestamp JH-TIME(i), and determines whether the designated timestamp is before the journal timestamp JH-TIME(i) (STEP 1306). If the designated timestamp is not older than the journal timestamp JH-TIME(i) (“No” in STEP 1306), the controller 42 extracts the next journal timestamp JH-TIME(i=i+1) (STEP 1305), and compares and determines it in the same manner (STEP 1306). If the designated timestamp is before the extracted journal timestamp JH-TIME(i) (“Yes” in STEP 1306), the controller 42 selects the journal timestamp JH-TIME(J=i−1) of the preceding node relative to the journal timestamp JH-TIME(i) currently referred to, and extracts journal data corresponding to any journal timestamps that are after the time indicated by the snapshot timestamp SS-TIME(S) that has been used for the restoration, and up to the now selected journal timestamp JH-TIME(J). The controller 42 sequentially applies the extracted journal data to the data volume 41a, thereby restoring the data volume 41a (STEP 1307). By way of this, with regard to the designated timestamp, data is restored using the journal data corresponding to the storage-based journal timestamp. Accordingly, in combination with the above restoration using the snapshot data, high-speed data restoration is realized.

If the designated timestamp is found in STEP 1301 to be based on the time in the host apparatus, the controller 42 first refers to the snapshot volume list in the volume management table, and extracts one item, i.e., the host-apparatus-based snapshot timestamp SS-HTIME(i) indicating the host-apparatus-based time that the snapshot processing was executed, from a node (STEP 1401 in FIG. 14). Then, the controller 42 compares the designated timestamp with the extracted snapshot timestamp SS-HTIME(i), and determines whether the designated timestamp is before the exacted snapshot timestamp SS-HTIME(i) (STEP 1402). If the specified timestamp is not older than the snapshot timestamp SS-HTIME(i) (“No” in STEP 1402), the controller 42 extracts the next snapshot timestamp SS-HTIME(i=i+1) (STEP 1401), and compares and determines it in the same way (STEP 1402). This extracting step is repeated until an applicable snapshot timestamp SS-HTIME(i) has been obtained. By way of this, the host-apparatus-based snapshot timestamp SS-HTIME(i) closest in time to the designated timestamp is obtained. If an applicable timestamp has not been obtained even after comparing the specified timestamp with all snapshot timestamps SS-HTIME(i) in the snapshot volume list, the controller 42 may return an error message to the host apparatus 2, and ends the processing.

If the designated timestamp is before the snapshot timestamp SS-HTIME(i) (“Yes” in STEP 1402), the controller 42 extracts the host-apparatus-based snapshot timestamp SS-HTIME(S=i−1) of the preceding node relative to the snapshot timestamp SS-HTIME(i) currently referred to, and checks whether there are one or more different snapshot timestamps SS-TIME(p) between the above two snapshot timestamps SS-HTIME(i) and SS-HTIME(S) (STEP 1403). The different snapshot timestamp SS-TIME(p) used here means a timestamp indicating a point in time that the snapshot processing was executed based on the time in the storage apparatus. If the storage apparatus 4 executes a snapshot independently from the host apparatus 2 (in other words, not based on requests from the host apparatus 2), or if a snapshot is executed based on a snapshot request including no host apparatus timestamp, the snapshot timestamp SS-TIME(p) will be stored in the snapshot volume list.

If there is no such different snapshot timestamp SS-TIME(p) (“No” in STEP 1403), the data volume 41a is recovered based on the snapshot data corresponding to the above extracted snapshot timestamp SS-HTIME(S) (STEP 1407). On the other hand, if there is such a different snapshot timestamp SS-TIME(p), the controller 42 performs the steps as depicted from STEP 1404 to STEP 1406, to extract the storage-apparatus-based snapshot timestamp SS-TIME(S′) corresponding to the designated host-apparatus-based timestamp.

Specifically, if there are one or more different snapshot timestamps SS-TIME(p) (“Yes” in STEP 1403), the controller 42 obtains the difference time 5T between the host-apparatus-based snapshot timestamp SS-HTIME(S) and the storage-apparatus-based snapshot timestamp SS-TIME(S) (STEP 1404). In other words, the controller 42 refers to the list data, i.e., the snapshot timestamps SS-TIME and SS-HTIME, in the same node of the snapshot volume list in the volume management table shown in FIG. 10.

Then, the controller 42 extracts a snapshot timestamp SS-TIME(S.offset), which is an offset timestamp obtained by offsetting the storage-apparatus-based snapshot timestamp SS-TIME(S) using the difference time δT (STEP 1405). The controller 42 compares the offset snapshot timestamp SS-TIME(S.offset) with the storage-apparatus-based snapshot timestamp SS-TIME(p), and determines whether the offset snapshot timestamp SS-TIME(S.offset) is after the storage-apparatus-based snapshot timestamp SS-TIME(p) (STEP 1406). If the snapshot timestamp SS-TIME(S.offset) is not after the snapshot timestamp SS-TIME(p), the controller 42 then obtains the next offset snapshot timestamp SS-TIME(S.offset=S.offset+1) (STEP 1405), and compares those timestamps in the same manner (STEP 1406). If the snapshot timestamp SS-TIME(S.offset) is after the snapshot timestamp SS-TIME(p), the controller 42 restores the data volume 41a based on the snapshot data corresponding to the snapshot timestamp SS-TIME(S.offset) currently referred to (STEP 1407).

Further, the controller 42 refers to the journal header area in the journal volume 41b, and extracts the host-apparatus-based journal timestamp JH-HTIME(j) indicating the host-apparatus-based point in time that journaling was performed (STEP 1408). Then, the controller 42 compares the designated timestamp with the extracted journal timestamp JH-HTIME(j), and determines whether the designated timestamp is before the journal timestamp JH-HTIME(j) (STEP 1409). If the designated timestamp is not older than the journal timestamp JH-HTIME(j) (“No” in STEP 1409), the controller 42 extracts the next journal timestamp JH-HTIME(j=j+1) (STEP 1408), and compares those timestamps in the same manner (STEP 1409). If the designated timestamp is older than the journal timestamp JH-HTIME(j) (“Yes” in STEP 1409), the controller 42 extracts the host-apparatus-based journal timestamp JH-HTIME(J=j−1) of the preceding node relative to the current host-apparatus-based journal timestamp JH-HTIME(j), and further checks whether there are one or more different journal timestamps JH-TIME(q) between the above two journal timestamps JH-HTIME(j) and JH-HTIME(J) (STEP 1410). The different journal timestamp used here means a timestamp indicating a point in time that journaling was performed based on the time in the storage apparatus.

If there is no such different journal timestamp JH-TIME(q) (No in STEP 1410), the data volume 41a of the past is restored by sequentially applying journal data corresponding to journal timestamps that are after the time indicated by the snapshot timestamp SS-TIME used above for reflecting data in the data volume 41a, and up to the above-obtained journal timestamp JH-HTIME(J), to the data volume 41a (STEP 1414).

If there are one or more different journal timestamps JH-TIME(q), the controller 42 performs steps as depicted from STEP 1410 to STEP 1413, to extract the storage-apparatus-based journal timestamp corresponding to the designated host-apparatus-based timestamp.

Specifically, if there are one or more different journal timestamps JH-TIME(q) (“Yes” in STEP 1410), the controller 42 obtains the difference time 5T between the preceding host-apparatus-based journal timestamp JH-HTIME(J), and its corresponding storage-apparatus-based journal timestamp JH-TIME(J) (STEP 1411). The controller 42 extracts a journal timestamp JH-TIME(J.offset), which is the offset timestamp obtained by offsetting the storage-apparatus-based journal timestamp JH-TIME(J) using the difference time δT (STEP 1412). Then, the controller 42 compares the offset journal timestamp JH-TIME(J.offset) with the storage-apparatus-based journal timestamp JH-TIME(j), and thereby determines whether the offset journal timestamp JH-TIME(J.offset) is before the storage-apparatus-based journal timestamp JH-TIME(j) (STEP 1413). If the journal timestamp JH-TIME(J.offset) is not before the journal timestamp JH-TIME(j), the controller 42 extracts the next offset journal timestamp JH-TIME(J.offset=J.offset+1), and compares those timestamps in the same manner. If the journal timestamp JH-TIME(J.offset) is older than the journal timestamp JH-TIME(j), the controller 42 restores the data volume 41a, by sequentially applying journal data corresponding to journal timestamps that are after the snapshot timestamp SS-TIME(S) used above for restoring the data volume 41a, and up to the preceding journal timestamp JH-HTIME(J.offset), to the data volume 41a (STEP 1414). By way of this, data as of a host-apparatus-based point in time as intended by the system administrator is restored.

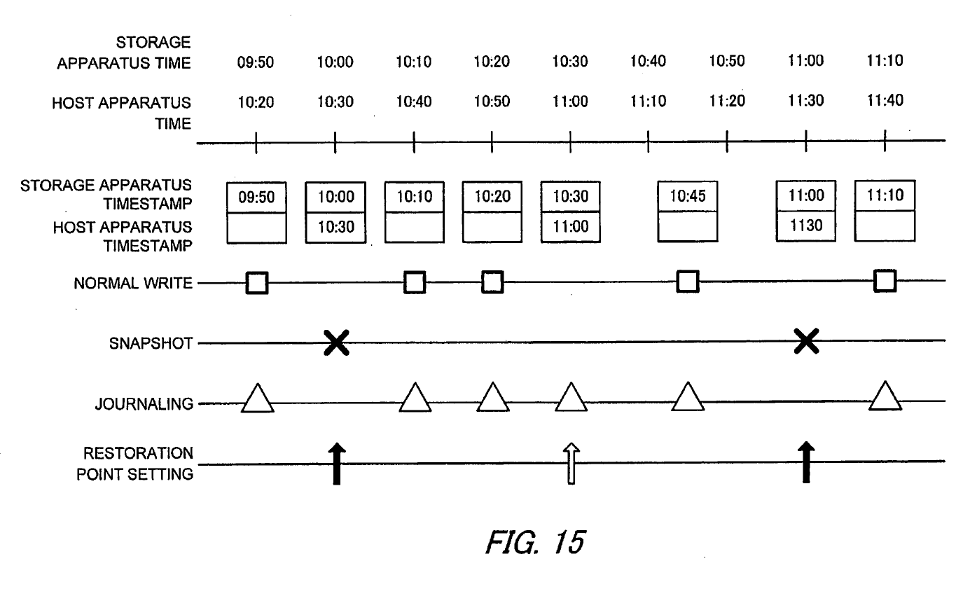

FIG. 15 is a time sequence for explaining data backup and restoration processing in a storage system according to an embodiment of the invention; namely, FIG. 15 illustrates the time sequence based on the times in the host apparatus and in the storage apparatus.

Referring to FIG. 15, the storage apparatus timestamps and the host apparatus timestamps are timestamps stored in the storage apparatus 4. As described before, for example, a snapshot timestamp is stored in the snapshot volume list when a snapshot is executed. Further, a journal timestamp is stored in the header area of the journal volume when journaling is performed. Only when a command including a host apparatus timestamp is sent from the host apparatus 2, can the storage apparatus 4 recognize that host apparatus timestamp, and thus so store it. Accordingly, if a command including a host apparatus timestamp is not sent from the host apparatus, the host apparatus timestamp is treated as null in the storage apparatus 4.

The “normal write” time sequence shows points in time when normal write request commands were issued. In FIG. 15, write request commands were issued at 9:50, 10:10, 10:20, 10:45 and 11:10, storage-apparatus-based time, and that data was written in accordance with those commands. Since normal write request commands include no host apparatus timestamp, the corresponding host apparatus timestamp is described as null.

The “restoration point setting” time sequence shows points in time when restoration point setting request commands were issued. As described before, the restoration point setting request commands are restoration management request commands where restoration point setting has been designated. In the restoration point setting request commands, it is possible to optionally designate whether the relevant processing involves snapshot processing or not. In FIG. 15, a black arrow shows a restoration point setting request command designating “With snapshots,” whereas a white arrow shows a restoration point setting request command designating “Without snapshots.”

The “journaling” time sequence shows points in time when journaling was performed in the storage apparatus 4. Journaling is performed together with the write processing in accordance with the normal write request commands, and it is also performed based on the restoration point setting request commands. Specifically, if a restoration point setting request command designates “Without snapshots,” the storage apparatus 4 performs journaling only. In FIG. 15, journaling was performed at 9:50, 10:10, 10:20, 10:30, 10:45 and 11:10, storage-apparatus-based time.

The “snapshot” time sequence shows points in time when snapshots were created in the storage apparatus 4. In part, snapshots are executed depending on the host apparatus 2, and, in part, snapshots are executed by the storage apparatus 4 independently of the host apparatus 2. The snapshots dependent on the host apparatus 2 are those executed in accordance with the restoration point setting request commands. In FIG. 15, the dependent snapshots were executed on the host apparatus at 10:00 and 11:00, storage-apparatus-based time.

Based on the above, if a user at the host apparatus 2 wishes to restore data on the data volume 41a as of the time of 10:40, host-apparatus-based time, the user designates the host-apparatus-based timestamp of 10:40, using a dialogue box provided by the storage manager.

In accordance with that user's instructions, the storage manager generates a restoration request command including the host-apparatus-based timestamp of “10:40” and transmits the command to the storage apparatus 4.

In response to the restoration request command, the controller 42 in the storage apparatus 4 refers to the snapshot volume list, searches for the host-apparatus-based snapshot timestamps sequentially from the oldest node, and, as a consequence of this, extracts that closest to the time of 10:40. In the example shown in FIG. 15, the snapshot timestamp indicating the time of 10:30 is extracted.

The controller 42 next refers to the journal header area in the journal volume, and searches for the host-apparatus-based journal timestamps, sequentially from the oldest node. In this example, however, there is no journal timestamp including any host apparatus timestamp until the journal timestamp indicating the time of 11:00. Thus, referring to the list data storing the host apparatus timestamp and the storage apparatus timestamp, associated one-to-one with each other, the controller 42 obtains a difference time δT between the time in the host apparatus and the time in the storage apparatus. In doing so, it will be found that the time in the host apparatus is 30 minutes behind the time in the storage apparatus. The controller 42 searches for any journal timestamp that has been offset from the storage-apparatus-based journal timestamp via the addition of the 30-minute difference time, and that indicates a time not after 10:40. In this example, the journal timestamp showing the time of 10:40, host-apparatus-based time (10:10, storage-apparatus-based time) is extracted.

Subsequently, the controller 42 applies the snapshot data corresponding to the above-extracted closest preceding snapshot timestamp (i.e., the snapshot data at 10:30, host-apparatus-based time) to the data volume 41a, and further applies the journal data corresponding to the above-extracted journal timestamp (i.e., the journal data at 10:10, storage-apparatus-based time) to the data volume 41a to which the above snapshot data had been already applied, thereby obtaining the data volume 41a of the past as intended. By way of this, data on the data volume 41a is restored based on the time in the host apparatus.

Several advantages result from a storage system of the present invention, some of which have been discussed above.

In the storage system 1 according to this embodiment, when the host apparatus 2 accesses to the storage apparatus 4, the host apparatus 2 transmits a command including an internally obtained host apparatus timestamp to the storage apparatus 4, and accordingly the storage apparatus 4 stores the transmitted host apparatus timestamp in a specific area. If the storage apparatus 4 receives a restoration request designating a time in the host apparatus from the host apparatus 2, the storage apparatus 4 restores data using the stored host apparatus timestamps. Thus, according to this embodiment, system administrators can restore data based on the time in the host apparatus.

Further, in the storage system 1 according to this embodiment, each restoration request designates whether data should be restored based on the time in the host apparatus or based on the time in the storage apparatus. Thus, according to this embodiment, the system administrators can restore data as of a proper point in time according to the reasons and content of the relevant failure.

Moreover, in the storage system 1 according to this embodiment, where a restoration request is made based on the time in the host apparatus, and even if the storage apparatus 4 does not store the corresponding host apparatus timestamp, the storage apparatus 4 can restore data to a point in time as close as possible to the time in the host apparatus designated in the restoration request, considering the time difference between the times in the host apparatus and in the storage apparatus.

As described above, according to this embodiment, the system administrators can restore data as expected.

The above-described embodiment is just an example for explaining the invention, and is not intended to limit the invention only to that embodiment. The invention can be embodied in other specific forms, without departing from the spirit of the invention. For example, in the above embodiment, the processing has been explained as being executed in sequential steps, but the invention is not limited to that. As long as no contradiction in operation is generated, the order of those steps may be changed, or some steps may be executed in parallel.

Further, in the storage system according to this embodiment, the storage manager is, as a management program, designed to issue various commands to the storage apparatus 4, but the invention is not limited to this. For example, an application program may be designed to issue various commands to the storage apparatus 4, by incorporating all or a part of the functions of the storage manager into the application program.

In addition, in the storage system according to this embodiment, the command management volume is established in the storage unit as one of the backup volumes, but the invention is not limited to this. For example, the command management volume may be established in the local memory in the controller.

The invention can be widely applied to storage apparatuses storing computer-processed data.

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A storage apparatus for backing up data and, in response to a restoration request from a host apparatus, restoring the backed-up data, the storage apparatus comprising:
a storage unit having a data volume and a backup volume formed therein; and
a controller connected to the storage unit and configured to control the storage unit,
wherein the controller, in accordance with a write request sent from the host apparatus, stores data associated with the write request into the data volume, and
wherein the controller, in accordance with a restoration point setting request sent from the host apparatus including a host apparatus timestamp, stores backup data associated with the host apparatus timestamp into the backup volume.

2. The storage apparatus according to claim 1, wherein the backup volume includes a journal volume, and wherein the controller stores into the journal volume the host apparatus timestamp included in the restoration point setting request, and a storage apparatus timestamp based on a time in the storage apparatus, in association with each other.

3. The storage apparatus according to claim 2, wherein the controller stores into the journal volume the host apparatus timestamp included in the restoration point setting request, and journal data based on the restoration point setting request, in association with each other.

4. The storage apparatus according to claim 3, wherein the backup volume includes a snapshot volume, and wherein the controller, if the restoration point setting request includes a request for a snapshot, stores snapshot data obtained by making the snapshot for the data volume into the snapshot volume.

5. The storage apparatus according to claim 4, the storage apparatus further comprising a snapshot volume table for managing the snapshot volume,
wherein the controller stores the host apparatus timestamp included in the restoration point setting request into the snapshot volume table.

6. The storage apparatus according to claim 5, wherein the controller, in accordance with the restoration point setting request, stores into the snapshot volume table the storage apparatus timestamp in association with the host apparatus timestamp.

7. The storage apparatus according to claim 6, wherein, in response to a restoration request sent from the host apparatus designating a storage apparatus timestamp, the controller restores data in manner of specifying snapshot data stored in the snapshot volume and applying the specified snapshot data to the data volume, and in manner of specifying journal data stored in the journal volume and applying the specified journal data to the data volume to which the specified snapshot data has been applied.

8. The storage apparatus according to claim 6, wherein, in response to a restoration request sent from the host apparatus and specifying a host apparatus timestamp, the controller restores data in manner of specifying snapshot data stored in the snapshot volume and applying the specified snapshot data to the data volume.

9. The storage apparatus according to claim 8, wherein the controller restores data in manner of specifying journal data stored in the journal volume and applying the specified journal data to the data volume to which the specified snapshot data has been applied.

10. The storage apparatus according to claim 6, wherein, in response to a restoration request sent from the host apparatus designating a host apparatus timestamp, the controller restores data in manner of obtaining a difference time based on the storage apparatus timestamp and the host apparatus timestamp stored in the snapshot volume table, specifying the snapshot data corresponding to the storage apparatus timestamp closest in time to the host apparatus timestamp that is included in the restoration request, in accordance with an offset timestamp based on the difference time, and applying the specified snapshot data to the data volume.

11. A data management method executed in a storage apparatus connected to a host apparatus, comprising:
interpreting an access request sent from the host apparatus; and
storing, if the access request is found to be a restoration point setting request as a result of the interpretation, backup data associated with a host apparatus timestamp included in the restoration point setting request into a backup volume.

12. The data management method according to claim 11, wherein the storing step comprises storing into a journal volume in the storage apparatus the host apparatus timestamp included in the restoration point setting request, and a storage apparatus timestamp based on a time in the storage apparatus, in association with each other.

13. The data management method according to claim 12, wherein the storing step comprises storing into the journal volume the host apparatus timestamp included in the restoration point setting request, and journal data based on the restoration point setting request, in association with each other.

14. The data management method according to claim 13, wherein the storing step comprises storing, if the restoration point setting request includes a request regarding a snapshot, snapshot data obtained by making the snapshot for the data volume, in a snapshot volume in the storage apparatus.

15. The data management method according to claim 14, wherein the storing step comprises storing the host apparatus timestamp included in the restoration point setting request into a snapshot volume table.

16. The data management method according to claim 15, wherein the storing step comprises storing, in accordance with the restoration point setting request, the storage apparatus timestamp into the snapshot volume table, in association with the host apparatus timestamp.

17. The data management method according to claim 16, further comprising restoring data, wherein the restoring step comprises, if the access request is found to be a restoration request as a result of the interpretation in the interpreting step, specifying particular snapshot data stored in the snapshot volume with reference to the storage apparatus timestamp included in the restoration request, applying the specified snapshot data to the data volume, also specifying particular journal data stored in the journal volume, and applying the specified journal data to the data volume to which the specified snapshot data has been applied.

18. The data management method according to claim 16, further comprising restoring data, wherein the restoring step comprises, if the access request is found to be a restoration request as a result of the interpretation in the interpreting step, specifying snapshot data stored in the snapshot volume with reference to the host apparatus timestamp included in the restoration request, and applying the specified snapshot data to the data volume.

19. The data management method according to claim 18, wherein the restoring step comprises, if the access request is found to be a restoration request as a result of the interpretation in the interpreting step, specifying particular journal data stored in the journal volume with reference to the host apparatus timestamp included in the restoration request, and applying the specified journal data to the data volume to which the specified snapshot data has been applied.

20. The data management method according to claim 16, wherein the restoring step comprises, if the access request is found to be a restoration request as a result of the interpretation in the interpreting step, obtaining a difference time based on the storage apparatus timestamp and the host apparatus timestamp stored into the snapshot volume table in association with each other, with reference to the host apparatus timestamp included in the restoration request; specifying the snapshot data corresponding to the storage apparatus timestamp closest in time to the host apparatus timestamp that is included in the restoration request, in accordance with an offset timestamp based on the difference time; and applying the specified snapshot data to the data volume.
